(19) United States
(12) Patent Application Publication
(10) Pub. No.: US 2003/0235737 A1
(43) Pub. Date: Dec. 25, 2003

(54) Metal-coated polymer electrolyte and method of manufacturing thereof

(76) Inventors: Yoocharn Jeon, Palo Alto, CA (US); Alfred I-Tsung Pan, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/173,825

(22) Filed: Jun. 19, 2002

(51) Int. Cl. H01M 8/10; H01M 4/86

(52) U.S. Cl. 429/30; 429/44; 427/115; 427/123

(57) ABSTRACT

Metal-coated polymer electrolyte membranes that are permeable to protons and hydrogen, and methods of manufacturing thereof are disclosed. The metal-covered polymer electrolyte membranes are capable of maintaining the proton and hydrogen permeability in a humidified environment. The metal-coated polymer electrolyte membranes can be used as proton exchange membranes in liquid-type fuel cells to prevent fuel, gas and impurity crossover.

### TECHNICAL FIELD

The technical field relates to metal-coated polymer electrolyte membranes, and in particular, to metal-coated polymer electrolyte membranes with a microtextured surface. The metal-coated, microtextured polymer electrolyte membrane can be used in electrochemical devices, such as fuel cells.

### BACKGROUND

In fuel cells employing liquid fuel, such as methanol, and an oxygen-containing oxidant, such as air or pure oxygen, the methanol is oxidized at an anode catalyst layer to produce protons and carbon dioxide. The protons migrate through the PEM from the anode to the cathode. At a cathode catalyst layer, oxygen reacts with the protons to form water. The anode and cathode reactions in this type of direct methanol fuel cell are shown in the following equations:

I: Anode reaction (fuel side): CH₃OH+H₂O→6H⁺+CO₂+6e⁻

II: Cathode reaction (air side): 3/2 O₂+6H⁺+6e⁻→3H₂O

III: Net: CH₃OH+3/2 O₂→2H₂O+CO₂

The two electrodes are connected within the fuel cell by an electrolyte to transmit protons from the anode to the cathode. The electrolyte can be an acidic or an alkaline solution, or a solid polymer ion-exchange membrane characterized by a high ionic conductivity. The solid polymer electrolyte is often referred to as a proton exchange membrane (PEM). PEMs such as Nafion™ are widely used in low temperature fuel cells, because of the electrolyte membrane's high proton conductivity and excellent chemical and mechanical stability. Since the electrolyte membrane is a polymer with a hydrophobic backbone and highly acidic side branches, the membrane must contain significant amounts of water to conduct protons from the electrode reactions. Therefore, the polymer electrolyte membrane is usually kept in a high humidity environment to maintain a high proton conductivity.

PEM fuel cells use basically the same catalyst for both anode and cathode. In addition to undergoing electro-oxidation at the anode, a water soluble liquid fuel, such as methanol, may permeate through the PEM and combines with oxygen on the surface of the cathode electrocatalyst. This process is described by equation III for the example of methanol. This phenomenon is termed “fuel crossover”. Fuel crossover lowers the operating potential of the oxygen electrode and results in consumption of fuel without producing useful electrical energy. In general, fuel crossover is a parasitic reaction which lowers efficiency, reduces performance and generates heat in the fuel cell. It is therefore desirable to minimize the rate of fuel crossover.

There are a number of approaches to reduce fuel crossover. The rate of crossover is proportional to the permeability of the fuel through the solid electrolyte membrane and increases with increasing fuel concentration and temperature. By choosing a PEM with low water content, the permeability of the membrane to the liquid fuel can be reduced. The reduced permeability for the fuel results in a lower crossover rate. Also, fuels having a large molecular size have a smaller diffusion coefficient than fuels having small molecular size. Hence, permeability can be reduced by choosing a fuel having a large molecular size. While water soluble fuels are desirable, fuels with moderate solubility exhibit lowered permeability. In addition, the permeability for vapors is higher than liquids, since fuels with high boiling points do not vaporize and their transport through the membrane is in the liquid phase, fuels with high boiling points generally have a low crossover rate. Furthermore, the wettability of the anode may be controlled by an optimum distribution of hydrophobic and hydrophilic sites, so that the anode structure may be adequately wetted by the liquid fuel to sustain electrochemical reaction, while excessive amounts of fuel are prevented from having access to the membrane electrolyte. Finally, the concentration of the liquid fuel can also be lowered to reduce the crossover rate.

In methanol fuel cells, fuel crossover is typically controlled by using diluted methanol fuel that contains 3% methanol and 97% water by weight. Because the reaction rate is proportional to the reactant, the low fuel concentration results in a low proton generation rate, which in turn leads to limited current drivability and voltage for a given current. Moreover, the fuel concentration gets lower and lower as the methanol is consumed and so does the power. Another problem is fuel efficiency. Since one water molecule (MW=18) is consumed with each methanol molecule (MW=34) in the electrochemical reaction, only about 1.6 wt % water will be consumed with methanol in a fuel composition containing only 3 wt % methanol, the other 95 wt % of water becomes “dead weight”. Therefore, the real “consumable fuel” in the diluted methanol fuel accounts to less than 5% of the total fuel composition.

Other approaches to prevent fuel crossover in fuel cells have been developed. WO 96/29752 to Grot et al. discloses the incorporation of various inorganic fillers into cation exchange membranes made from polymers to decrease fuel crossover. U.S. Pat. No. 5,631,099 to Hockaday discloses fuel cell electrodes having thin films of catalyst and metal materials deposited on fiber reinforced porous membranes. It is suggested that the thin film electrode structure provides the capability to filter the reactant streams of various species, such as carbon monoxide or methanol if the metal electrode materials have selective permeability to hydrogen. U.S. Pat. No. 6,248,469 to Formato et al. discloses composite solid polymer electrolyte membranes which include a porous polymer substrate interpenetrated with an ion-conducting material. Fuel crossover resistance of the membranes can be optimized by using the proper blend of different polymers. None of these approaches, however, has provide satisfactory results.

U.S. Pat. No. 5,759,712 to Hockaday describes a hydrogen-only permeable electrode to block fuel crossover. The invention, however, requires an elaborated membrane structure that contains three layers of metal deposited on a porous membrane. Therefore, there remains a need for fuel-impermeable electrolyte membranes that are easily manufactuable.

### SUMMARY

Metal-coated polymer electrolyte membranes that are permeable to protons/hydrogen atoms and methods of manufacturing such membranes are disclosed. A surface of the polymer electrolyte membrane is treated to form a microstructure that helps the metal coating to relieve surface tension and to prevent expansion-induced cracking of the metal coating. In addition, the polymer electrolyte membrane can be preexpanded in a soaking composition before the coating process. The proton/hydrogen atom permeable, metal-coated polymer electrolyte membrane can be used to prevent fuel, gas and impurity crossover in fuel cell applications.

### BRIEF DESCRIPTION OF THE DRAWINGS

The detailed description will refer to the following drawings, in which like numerals refer to like elements, and in which:

FIGS. 1A and 1B depict changes of continuality of a thin metal film under polymer electrolyte membrane expansion.

FIGS. 2A and 2B depict embodiments of a microtextured surface.

FIGS. 3A and 3B depict another embodiment of a microtextured surface.

FIGS. 4A and 4B depict another embodiment of a microtextured surface and various cross-sections of such a surface.

FIGS. 5A and 5B depict another embodiment of a microtextured surface and various cross-sections of such a surface.

FIGS. 6A and 6B show embodiments of producing polymer electrolyte membranes with a microtextured surface using a mold.

FIG. 7 depicts a process flow for mold fabrication.

FIG. 8 depicts an embodiment of a microtextured mold.

FIG. 9 depicts a process flow for coating a polymer electrolyte membrane using a pre-soaking method.

FIG. 10 depicts a process flow for coating a polymer electrolyte membrane using a double-coating method.

FIG. 11 depicts an embodiment of a metal coat on a polymer electrolyte membrane.

### DETAILED DESCRIPTION

An ideal polymer electrolyte membrane in a PEM fuel cell should have the following properties: high ion conductivity, high electrical resistance, and low permeability to fuel, gas or other impurities. However, none of the commercially available PEMs possesses all those properties. For example, the most popular PEM, Nafion™ exhibits high fuel crossover.

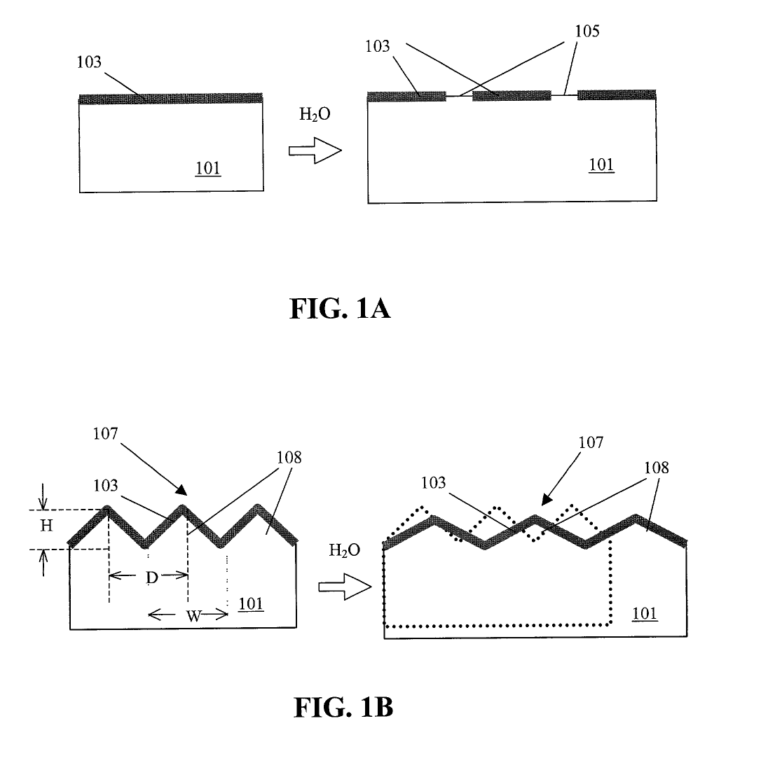

One approach to block fuel crossover is to coat the polymer electrolyte membrane with a thin layer of metal, such as palladium (Pd), which is known to be permeable to proton/hydrogen but impermeable to hydrocarbon fuel molecules. The major problem with the metal coating, however, is the cracking of the metal film during hydration when the polymer electrolyte membrane that the metal film covers expands in volume. As demonstrated in FIG. 1A, when a polymer electrolyte membrane 101 covered with a thin metal film 103 is placed in a high humidity environment, the polymer electrolyte membrane 101 absorbs the water and expands in volume. The volume expansion leads to an enlarged surface area and creates very high stress in the thin metal film 103, which eventually results in cracks 105 in the thin metal film 103. Fuel molecules can then permeate the polymer electrolyte membrane 101 through the cracks 105.

The expansion-induced cracking of the metal film 103 can be avoided by creating a microtextured surface 107 on the polymer electrolyte membrane 101. As shown in FIG. 1B, the microtextured surface 107 contains many protrusions 108 that flatten out when the polymer electrolyte membrane 101 expands in water. During the flattening process, the thin metal film 103 covering the microtextured surface 107 relieves the expansion-induced stress by rotating towards the center plane of the polymer electrolyte membrane 101, while maintaining the continuity of the metal film 103. The protrusions 108 can be separated from each other by a flat surface of limited size.

The polymer electrolyte membrane 101 is a sulfonated derivative of a polymer that includes a lyotropic liquid crystalline polymer, such as a polybenzazole (PBZ) or polyaramid (PAR or Kevlar™) polymer. Examples of polybenzazole polymers include polybenzoxazole (PBO), polybenzothiazole (PBT) and polybenzimidazole (PBI) polymers. Examples of polyaramid polymers include polypara-phenylene terephthalimide (PPTA) polymers.

The polymer electrolyte membrane 101 also includes a sulfonated derivative of a thermoplastic or thermoset aromatic polymer. Examples of the aromatic polymers include polysulfone (PSU), polyimide (PI), polyphenylene oxide (PPO), polyphenylene sulfoxide (PPSO), polyphenylene sulfide (PPS), polyphenylene sulfide sulfone (PPS/SO₂), polyparaphenylene (PPP), polyphenylquinoxaline (PPQ), polyarylketone (PK) and polyetherketone (PEK) polymers.

Examples of polysulfone polymers include polyethersulfone (PES), polyetherethersulfone (PEES), polyarylsulfone, polyarylethersulfone (PAS), polyphenylsulfone (PPSU) and polyphenylenesulfone (PPSO₂) polymers.

Examples of polyimide polymers include the polyetherimide polymers as well as fluorinated polyimides.

Examples of polyetherketone polymers include polyetherketone (PEK), polyetheretherketone (PEEK), polyetherketone-ketone (PEKK), polyetheretherketoneketone (PEEKK) and polyetherketoneetherketone-ketone (PEKEKK) polymers.

The polymer electrolyte membrane 101 may include a sulfonated derivative of a non-aromatic polymer, such as a perfluorinated ionomer. Examples of ionomers include carboxylic, phosphonic or sulfonic acid substituted perfluorinated vinyl ethers.

The polymer electrolyte membrane 101 may also include a sulfonated derivative of blended polymers, such as a blended polymer of PEK and PEEK.

The polymer electrolyte membrane 101 may have a composite layer structure comprising two or more polymer layers. Examples of composite layer structures are Nafion™ or PBI membranes coated with sulfonated polyetheretherketone (sPEEK) or sulphonated polyetheretherketone-ketone (sPEEKK). The polymer layers in a composite layer structure can be either blended polymer layers or unblended polymer layers or a combination of both.

The polymer electrolyte membrane 101 is chemically stable to acids and free radicals, and thermally/hydrolytically stable to temperatures of at least about 100° C. Preferred polymer electrolyte membranes 101 have an ion-exchange capacity (IEC) of >1.0 meq/g dry membrane (preferably, 1.5 to 2.0 meq/g) and are highly ion-conducting (preferably from about 0.01 to about 0.5 S/cm).

Preferred polymer electrolyte membranes 101 are fluorocarbon-type ion-exchange resins having sulfonic acid group functionality and equivalent weights of 800-1100, including Nafion™ membranes.

The microtextured surface 107 on the polymer electrolyte membrane 101 comprises a plurality of the protrusions 108. The protrusions 108 can be in a shape of waves, ripples, pits, nodules, cones, polyhedron, or the like, so long as most of the surfaces of the protrusions 108 form an angle with a central plane of the polymer electrolyte membranes 101 and there are minimal flat surfaces between the protrusions 108.

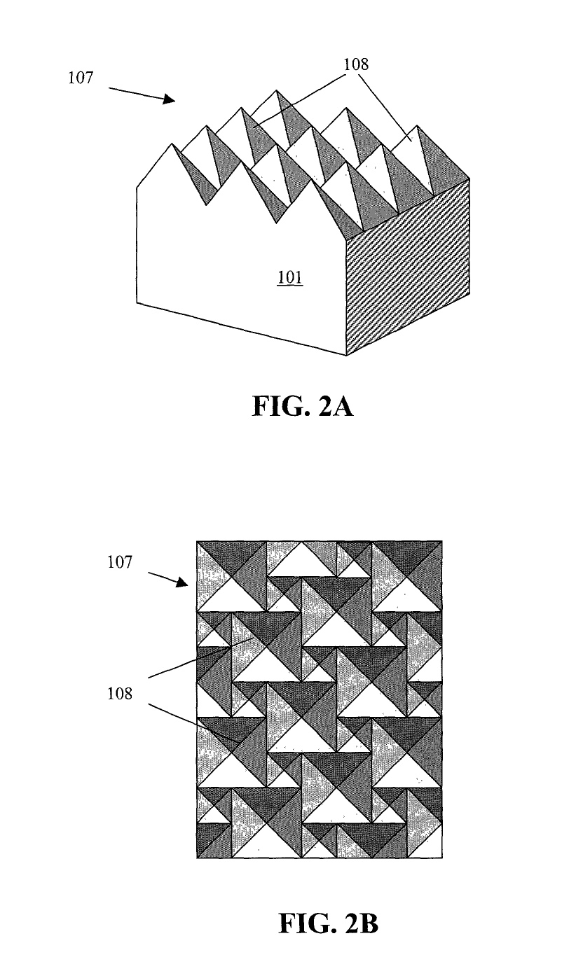

FIG. 2A depicts an embodiment of the microtextured surface 107 wherein the protrusions 108 are in a pyramidal shape with no space between protrusions. In this embodiment, all surfaces on the protrusions 108 form an angle with the central plane of the polymer electrolyte membranes 101. FIG. 2B depicts a related embodiment wherein the protrusions 108 have different sizes.

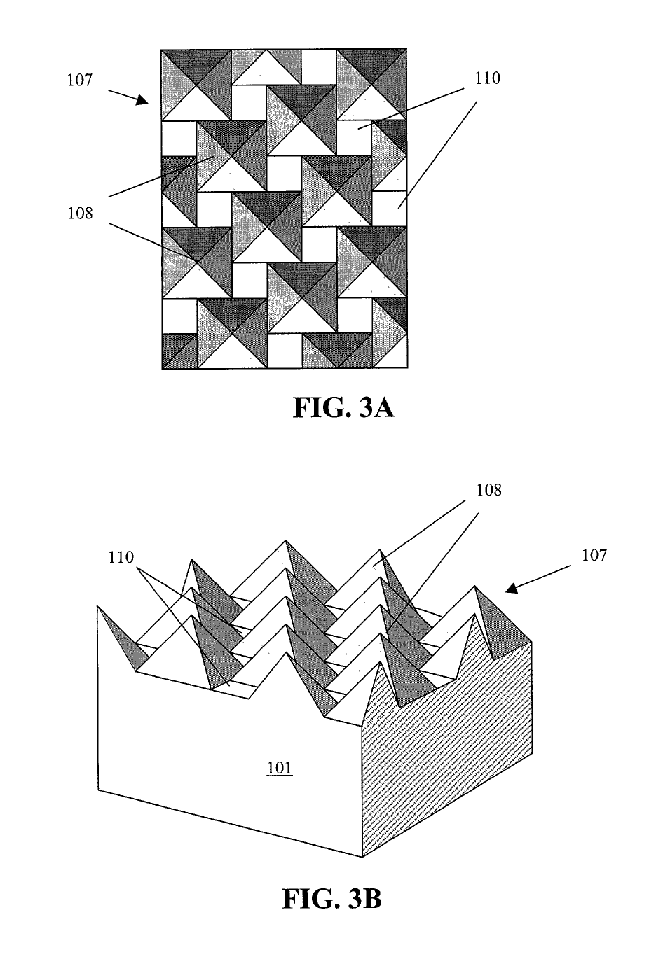

FIGS. 3A and 3B depict a related embodiment wherein the protrusions 108 are in a pyramidal shape but with some limited flat surfaces 110 between protrusions. The surfaces 110 can be parallel to the central plane of the polymer electrolyte membranes 101, so long as the surfaces 110 are of limited size and are flanked by protrusions 108 to relieve the expansion-induced stress in the metal coating covering these surfaces. The protrusions 108 in FIGS. 2A, 2B, 3A and 3B can also be in truncated pyramidal shapes, so long as all the surfaces parallel to the central plane are of limited size and are flanked by surfaces that form an angle with the central plane.

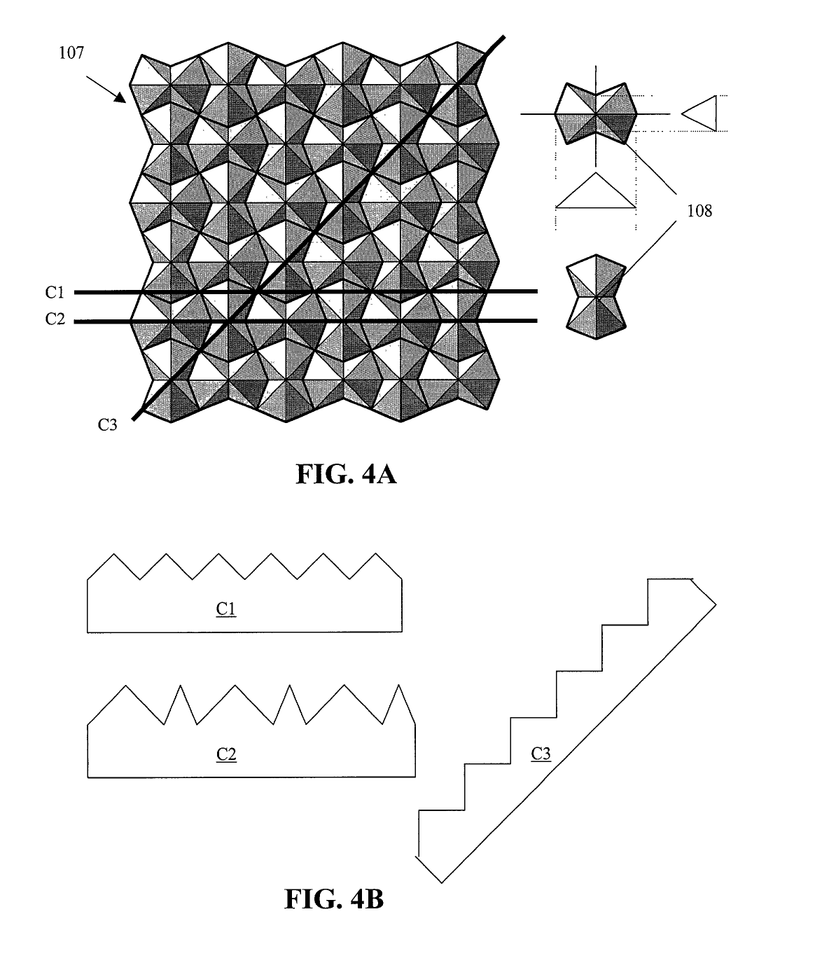

FIG. 4A shows another embodiment of a microtextured surface 107 wherein each protrusion 108 has a polyhedral shape. As shown in FIG. 4B, the surface contours of cross-sections C1, C2 and C3 of the microtextured surface 107 contain no straight surface line parallel to the central plane of the membrane 101.

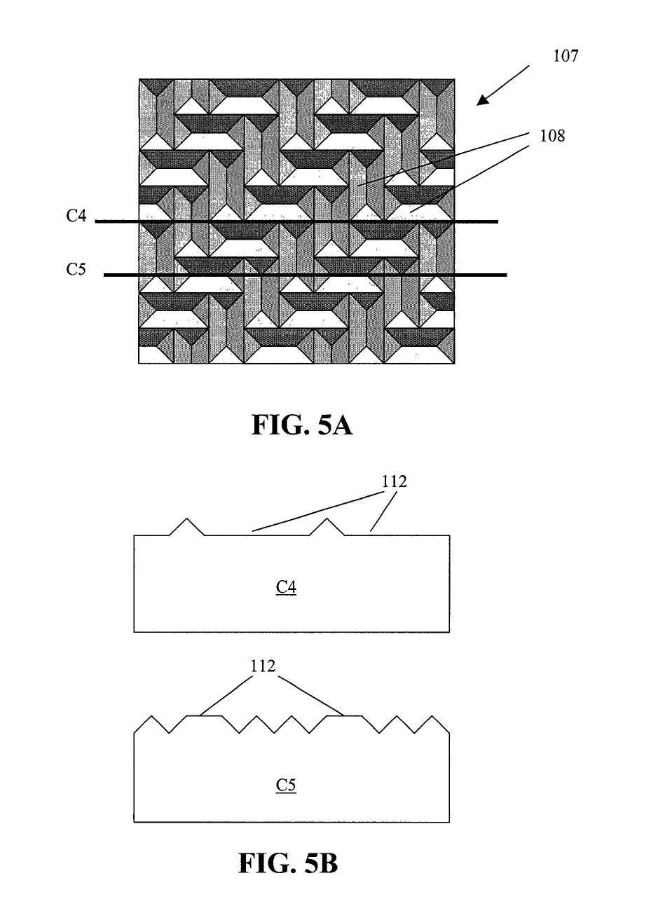

FIG. 5A depicts another embodiment of a microtextured surface 107 having roof-like protrusions 108. This embodiment has no flat surface parallel to the central plane of the membrane 101. However, as shown in the cross-sectional views in FIG. 5B, some “roof” edge lines 112 are parallel to the central plane of the membrane 101. Those parallel lines 112 are tolerated because they are of limited length and are flanked by angled surfaces.

Many other embodiments are possible for the microtextured surface 107 with protrusions 108 of different shapes and sizes. The dimension and layout of the protrusions 108 are generally defined by the average height (H) and average width (W) of the protrusions 108, as well as the average distance (D) between neighboring protrusions (FIG. 1B). The optimal H, D and W values of a particular surface structure depend on the thickness of the metal coating. Typically, the height (H) of the protrusions 108 is at least three-times greater than the thickness of the metal film 103 so that the contour of protrusions 108 is maintained after coating with the metal film 103.

The microtextured surface 107 on the polymer electrolyte membranes 101 may be created by any chemical, physical or mechanical process that is capable of generating surface microstructures of desired shape and size. In an embodiment, the microtextured surface 107 is generated by exposing a surface of the polymer electrolyte membranes 101 to a microfabrication process such as sand grinding, wet and/or dry chemical etching, plasma etching, silicon micromachining, laser machining, and precision mechanical machining.

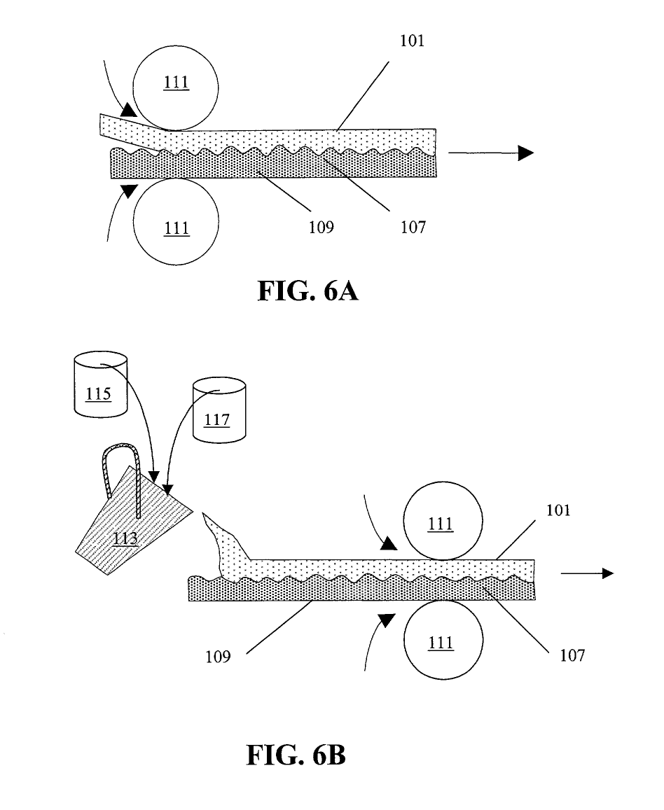

In another embodiment, the microtextured surface 107 is created by hot embossing a surface of the polymer electrolyte membrane 101 with a microtextured mold 109 using rollers 111 (FIG. 6A).

In yet another embodiment, the microtextured surface 107 on the polymer electrolyte membrane 101 is created by direct casting onto the microtextured mold 109. As shown in FIG. 6B, a mixture 113 comprising ion-exchange resins 115 and a solvent 117 is poured onto the microtextured mold 109 and pressed by the rollers 111 to form the polymer electrolyte membrane 101 with a microtextured surface 107. Alternatively, the mixture 113 may be cast onto the microtextured mold 109 and solidified into the polymer electrolyte membrane 101 having the microtextured surface 107.

Examples of ion-exchange resins 115 include hydrocarbon- and fluorocarbon-type resins. Hydrocarbon-type ion-exchange resins include phenolic or sulfonic acid-type resins; and condensation resins such as phenol-formaldehyde, polystyrene, styrene-divinyl benzene copolymers, styrene-butadiene copolymers, styrene-divinylbenzene-vinylchloride terpolymers, and the like, that are imbued with cation-exchange ability by sulfonation.

Fluorocarbon-type ion-exchange resins include hydrates of a tetrafluoroethylene-perfluorosulfonyl ethoxyvinyl ether or tetrafluoroethylene-hydroxylated (perfluoro vinyl ether) copolymers. When oxidation and/or acid resistance is desirable, such as at the cathode of a fuel cell, fluorocarbon-type resins having sulfonic, carboxylic and/or phosphoric acid functionality are preferred. Fluorocarbon-type resins typically exhibit excellent resistance to oxidation by halogens, strong acids and bases, and can be preferable for composite electrolyte membranes. One family of fluorocarbon-type resins having sulfonic acid group functionality is the Nafion™ resin family (DuPont Chemicals, Wilmington, Del., available from ElectroChem, Inc., Woburn, Mass., and Aldrich Chemical Co., Inc., Milwaukee, Wis.). Other fluorocarbon-type ion-exchange resins that can be useful in the invention comprise (co)polymers of olefins containing aryl perfluoroalkyl sulfonylimide cation-exchange groups, having the general formula (I): CH₂═CH—Ar—SO₂—N⁻—SO₂ (C₁₊ₙ F₃₊₂ₙ), wherein n is 0-11, preferably 0-3, and most preferably 0, and wherein Ar is any substituted or unsubstituted divalent aryl group, preferably monocyclic and most preferably a divalent phenyl group. Ar may include any substituted or unsubstituted aromatic moieties, including benzene, naphthalene, anthracene, phenanthrene, indene, fluorene, cyclopentadiene and pyrene, wherein the moieties are preferably molecular weight 400 or less and more preferably 100 or less. Ar may be substituted with any group as defined herein.

The solvent 117 includes, but is not limited to: tetrahydrofuran (THF), dimethylacetamide (DMAc), dimethylformamide (DMF), dimethylsulfoxide (DMSO), N-Methyl-2-pyrrolidinone (NMP), sulfuric acid, phosphoric acid, chlorosulfonic acid, polyphosphoric acid (PPA), methanesulfonic acid (MSA), lower aliphatic alcohols, water, and a mixture thereof.

The microtextured mold 109 can be produced by any micro fabrication process that is capable of generating surface protrusions 108 of desired shape and dimension.

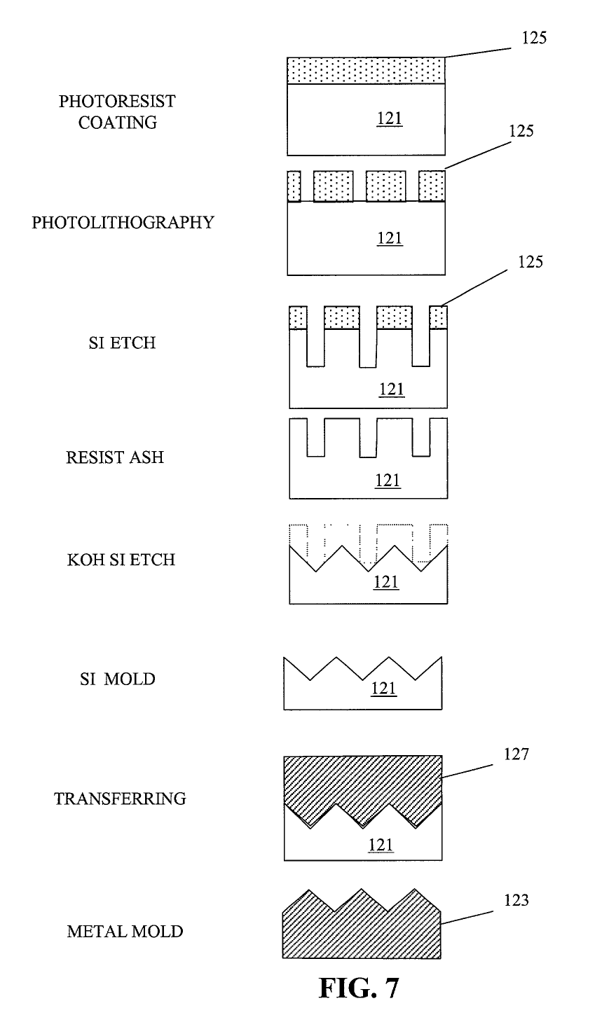

In an embodiment, the microtextured mold 109 is made by photolithography and anisotropic etching of a single crystalline silicon wafer 121. As shown in FIG. 7, the microtextured mold 109 is fabricated through the following steps:

1. Spin-coating the silicon wafer 121 with a layer of photoresist 125. In this process, the photoresist 125 is in a solution with a volatile liquid solvent. The solution is poured onto the silicon wafer 121, which is rotated at high speed. As the liquid spreads over the surface of the wafer, the solvent evaporates, leaving behind a thin film of the photoresist 125 with a thickness of 0.1-50 μm.

2. Exposing the photoresist 125 to ultraviolet light through a photomask, and washing away the exposed photoresist 125 with the aid of a chemical developer. The remaining photoresist 125 forms a desired pattern on the silicon wafer 121.

3. Anisotropically etching the silicon wafer 121 to a depth of \sqrt{2}/2×D (D is the distance between two neighboring pattern units, i. e., the distance between the two neighboring protrusions 108, as shown in FIG. 1B) by RIE using fluorine- or chlorine-containing gases and a polymer forming gas.

4. Removing the photoresist 125 by exposing the silicon wafer 121 to oxygen plasma to burn the photoresist 125 or by immersing the wafer 121 into a photoresist removal solution or solvent.

5. Anisotripically etching the silicon wafer 121 using KOH, which has 100 times lower etch rate for (111) surface than for differently oriented surfaces. The KOH etching produces pyramid-shaped wells centered at the opening in the silicon wafer 121. Since all other surfaces but (111) are etched much faster than (111) surface, at last only (111) surfaces remain. Once all the other surfaces disappear, the etch rate falls drastically.

6. Transferring the microtextured surface on the silicon wafer 121 to a metal mold 123. The transfer of surface structure can be accomplished by depositing a metal layer 127 on top of the silicon wafer 121 by electro- or electroless-plating, and then dissolving the silicon wafer 121 to generate the metal mold 123.

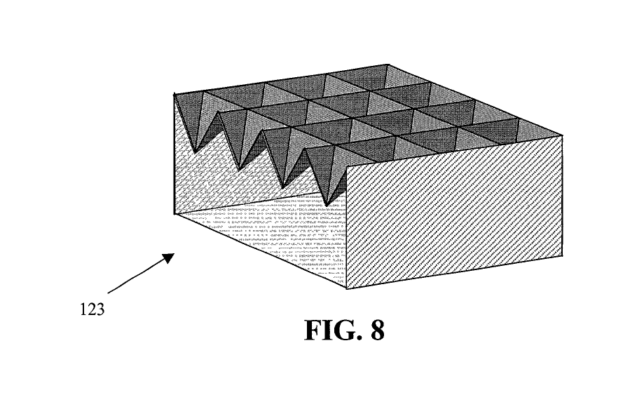

The final product is shown in FIG. 8. The surface structure of the metal mold 123 is a negative replica of the microtextured surface of the silicon wafer 121. The metal mold 123 can be used as the microtextured mold 109 to produce the polymer electrolyte membrane 101 having the microtextured surface 107 shown in FIG. 2A.

In another embodiment, the surface textured silicon wafer 121 or the metal mold 123 may be coated with a thin sacrificial layer, followed with a proton/hydrogen permeable metal film. The metal film-coated mold is then used to produce a microstructure on a surface of a polymer electrolyte membrane. Finally, the proton/hydrogen permeable metal film is removed from the silicon wafer 121 or the metal mold 123, and is placed on top of the microstructure of the surface of polymer electrolyte membrane to form a metal coated polymer electrolyte membrane.

The microtextured mold 109 can also be fabricated by other commonly used surface treatment processes such as LIGA (a technique used to produce micro electromechanical systems made form metals, ceramics, or plastics utilizing x-ray synchrotron radiation as a lithographic light source), wet chemical etching, dry chemical etching, precession mechanical machining, and laser machining.

The metal film 103 can be deposited onto the microtextured surface 107 of the polymer electrolyte membrane 101 by electroplating, electroless plating, sputtering, evaporation, atomic layer deposition, chemical vapor deposition, or any other process that is capable of coating the surface of a non-conductive material. The thin metal film 103 comprises a metal or an alloy that is permeable to protons/hydrogen but is not permeable to hydrocarbon fuel molecules, gases such as carbon monoxide (CO), or impurities in the fuel such as sulfur. Examples of such metals or alloys include palladium (Pd), platinum(Pt), niobium (Nb), vanadium (V), iron (Fe), tantalum (Ta), and alloys thereof.

The metal film 103 can be a discontinuous layer of metal particles, so long as the distances between the metal particles are small enough to prevent fuel, gas and impurity crossover in a particular application. The thin metal film 103 can also be a composite film comprising multiple layers. For example, Pd and Pt are more corrosion-resistant than Nb, V, Fe and Ta. Therefore, a composite thin metal film 103 may comprise a first layer of Nb, V, Fe, Ta or a alloy thereof, which is covered by a second layer of Pt, Pd or an alloy thereof.

The metal film 103 needs to be thin enough so that the contour of the microtextured surface 107 is preserved. In another word, the thickness of the metal film 103 should be relatively small compared to the dimensions of the protrusions 108 on the microtextured surface 107. Typically, the thickness of the thin metal film 103 is smaller than the average height (H) of surface structures 108. Preferably, the thickness of the thin metal film 103 is no greater than one third of the average height (H) of the protrusions 108.

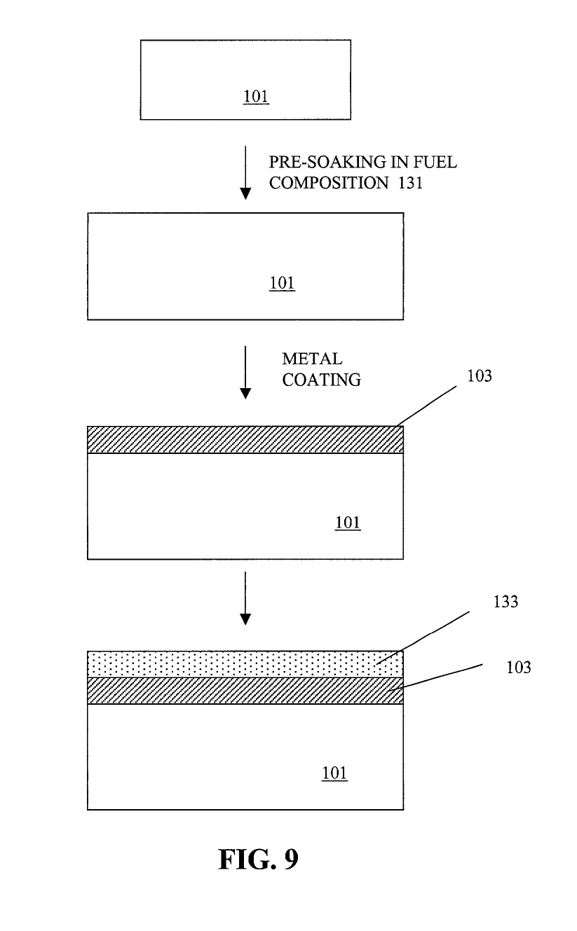

FIG. 9 depicts an alternative approach to avoiding expansion-induced cracking in metal coating. In this embodiment, the polymer electrolyte membrane 101 is soaked in a soaking composition 131 to allow the expansion to occur. The soaking composition 131 can be any fuel composition that results in an expansion in volume of the polymer electrolyte membrane 101. The expanded polymer electrolyte membrane 101 is then coated with the thin metal film 103 to prevent fuel crossover. The metal coated electrolyte membrane 101 can be kept wet throughout the following manufacturing process so that the membrane remain expanded and the integrity of the metal coating 103 is maintained. In this embodiment, even if the expanded polymer electrolyte membrane 101 becomes dry and shrink in volume, the metal film 103 will not crack because the shrinkage of the polymer electrolyte membrane 101 only induces compression stress in the metal film 103 which, unlike the expansion-induced tension, will not result in cracks in the metal film 103.

Different fuel compositions may lead to membrane expansion of different scales. For example, soaking a Nafion™ membrane in pure water results in a 20% increase in volume, while soaking the same membrane in pure methanol results in a 40% increase in volume. Thus, a polymer electrolyte membrane 101 immersed in a water/methanol fuel composition may change its volume when the water:methanol ratio of the fuel composition changes due to fuel consumption. Generally, when the water:methanol ratio of the fuel composition increases, such as in the case of normal fuel consumption in a fuel cell, the volume of the polymer electrolyte membrane 101 decreases. Conversely, when the water:methanol ratio of the fuel composition decreases, such as in the case of adding new fuel to a fuel cell, the volume of the polymer electrolyte membrane 101 increases. For example, if the starting water:methanol ratio of a fuel composition is 50:50 by weight and, after a certain period of fuel consumption, the water:methanol ratio of the fuel composition becomes 90:10 by weight, the volume of the polymer electrolyte membrane will decrease accordingly.

To avoid any dramatic volume change, especially a significant increase in volume of the pre-soaked polymer electrolyte membrane 101 during the operation of a fuel cell, the polymer electrolyte membrane 101 is pre-soaked and expanded to such an extent before the coating of metal film 103 so that the after-coating volume change is minimized. If the type of fuel and the possible range of change in fuel composition are known before the manufacturing of a metal coated polymer electrolyte membrane, a proper soaking composition 131 can be selected to expand the polymer electrolyte membrane 101 to such an extent that the expanded polymer electrolyte membrane 101 will only subjected to shrinkage in future use. For example, if the polymer electrolyte membrane 101 is to be used in a methanol fuel cell wherein the water:methanol ratio in the fuel may vary from 50:50 by weight (fresh fuel) to 99:1 by weight (when most of the methanol in the fuel is consumed), the polymer electrolyte membrane 101 will be soaked in a soaking composition 131 containing 50% water and 50% methanol by weight.

In one embodiment, the polymer electrolyte membrane 101 is perfluorosulfonic acid polymer. The perfluorosulfonic acid polymer membrane is immersed in a soaking composition 131 containing 50% water and 50% methanol by weight. The expanded polymer electrolyte membrane 101 is kept wet and then coated with a thin layer of Pd through electroless plating. In a related embodiment, the polymer electrolyte membrane 101 is soaked in a soaking composition 131 having a methanol concentration higher than 50% by weight and is then coated with a thin layer of Pd. In this case, the expanded polymer electrolyte membrane 101 will shrink in volume in a normal service environment of 50% water and 50% methanol. Accordingly, this shrinkage will impose a slight compressive stress on the Pd film coating the expanded polymer electrolyte membrane 101. A slight compressive stress can also be introduced into the Pd film during the deposition process. The built-in compressive stress will then counteract any expansioninduces tension in the Pd coating.

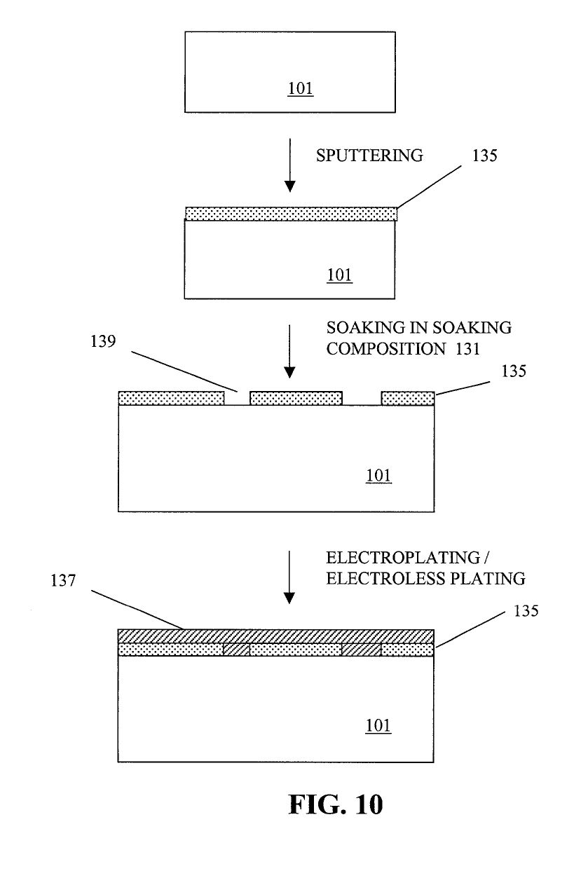

FIG. 10 shows another embodiment wherein an unexpanded polymer electrolyte membrane 101 is coated with a first metal film 135 by sputting or other applicable processes. The coated polymer electrolyte membrane 101 is then soaked in the soaking composition 131. The resulting membrane expansion will lead to cracks 139 in the first metal film 135. The cracks 139 are then sealed by electroless plating or electroplating of a second metal film 137. In this embodiment, the first metal film 135 serves as a seed layer to enhance adhesion of the second metal film 137 to the polymer electrolyte membrane 101.

The pre-soaking procedure can also be used in combination with the microtextured surface to prevent expansion-induced cracking in the metal film 103. Both sides of the polymer electrolyte membrane 101 can be metal coated, so that the polymer electrolyte membrane 101 is sandwiched between two layers of thin metal film 103.

The metal-coated polymer electrolyte membranes may be used as PEMs in low temperature fuel cells, and preferably in PEM-based direct methanol fuel cells. In an embodiment, one side of the PEM is microtextured and covered by the thin metal film 103 to prevent fuel crossover. In another embodiment, both sides of the PEM are microtextured and covered by the thin metal film 103. In yet another embodiment, the metal-coated polymer electrolyte membrane is subjected to an electroless plating process after hydration to cure any minor cracks in the metal film. The electroless plating process can be performed in the fuel cell where the metal-coated polymer electrolyte membrane serves as a PEM.

As shown in FIG. 9, the metal-coated polymer electrolyte membrane 101 may be further coated with a layer of catalyst 133 to form a catalytic, fiel-impermeable polymer electrolyte membrane. Examples of the catalyst 133 include, but are not limited to, any noble metal catalyst system. Such catalyst systems comprise one or more noble metals, which may also be used in combination with non-noble metals. One preferred noble metal material comprises an alloy of platinum (Pt) and ruthenium (Ru). Other preferred catalyst systems comprise alloys of platinum and molybdenum (Mo); platinum and tin (Sn); and platinum, ruthenium and osmium (Os). Other noble metal catalytic systems may be similarly employed. The catalyst 133 can be deposited onto the metal film 103 by electroplating, sputtering, atomic layer deposition, chemical vapor deposition, or any other process that is capable of coating the surface of a conductive material.

The metal film 103 itself may also serve as a catalyst, such as in the case of Pd or Pd alloy. The reactivity of the catalyst can be enhanced by a plasma oxidization process or by using a porous deposit of fine catalyst powders such as Pt black and Pd black, Both Pt black and Pd black have been used as surface modification of electrodes to improve the hydrogenation rate. For example, see Inoue H. et al. “Effect of Pd black deposits on successive hydrogenation of 4-methylstyrene with active hydrogen passing through a Pd sheet electrode” Journal of The Electrochemical Society, 145: 138-141, 1998; Tu et al. “Study of the powder/membrane interface by using the powder microelectrode technique I. The Pt-black/Nafion® interfaces” Electrochemica Acta 43:3731-3739, 1998; and Cabot et al. “Fuel cells based on the use of Pd foils” Journal of New Materials for Electrochemical Systems 2:253-260, 1999.

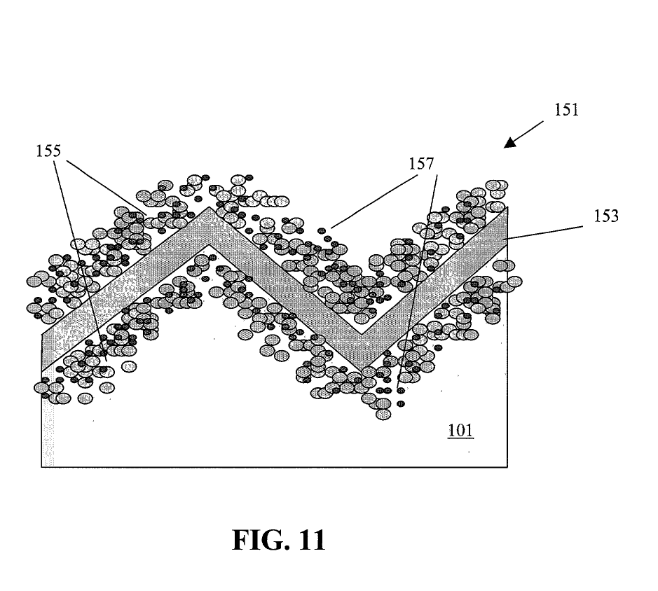

FIG. 11 depicts an embodiment wherein a proton/hydrogen permeable metal film 151 comprises a continuous metal layer 153 sandwiched between two porous metal layers 155. The porous metal layers 155 are further coated with catalyst particles 157 such as particles of platinum or platinum-ruthenium alloy. The porous metal layers 155 increase reaction surface area, improve reaction rate, and provide mechanical interlocking between the metal film 151 and the electrolyte membrane 101.

In an embodiment, a PEM-electrode structure is manufactured utilizing a polymer electrolyte membrane that is microtextured and coated on both sides with the thin metal film 103 and a catalyst. Porous electrodes that allow fuel delivery and oxygen exchange are then pressed against the catalyst layers of the PEM to form the PEM-electrode structure, which can be used in fuiel cell applications.

Although preferred embodiments and their advantages have been described in detail, various changes, substitutions and alterations can be made herein without departing from the spirit and scope of the metal-coated polymer electrolyte membrane as defined by the appended claims and their equivalents.

We claim:

1. A method for producing a metal-coated polymer electrolyte membrane, said method comprising:
fabricating a mold having a microtextured surface;
producing a microstructure on a surface of a polymer electrolyte membrane using the mold having the microtextured surface; and
depositing a metal film on the microtextured surface of the polymer electrolyte membrane,
wherein the metal film is permeable to protons and hydrogen.

2. The method of claim 1, wherein the microtextured surface on the mold is fabricated by a process comprising steps of:
creating a pattern on a surface of a single crystalline silicon wafer by photolithography, and
anisotropically etching the single crystalline silicon wafer.

3. The method of claim 1, wherein the microtextured surface on the mold is fabricated by a process comprising steps of:
creating a pattern on a surface of a single crystalline silicon wafer by photolithography,
anisotropically etching the single crystalline silicon wafer, and
transferring the pattern to a metal mold.

4. The method of claim 3, wherein the step of transferring the microtextured surface on the silicon wafer to a metal mold comprising steps of:
depositing a metal layer onto the microtextured surface of the silicon wafer, and
detaching the metal layer from the silicon wafer.

5. The method of claim 1, wherein the microtextured surface on the mold is fabricated by a process comprising the following steps:
spin-coating a silicon wafer with a layer of photoresist;
exposing the photoresist to UV light through a photomask;
developing the exposed photoresist to obtain a desired shape of photoresist on the silicon wafer;
anisotropically etching the silicon wafer into a depth of \sqrt{2}/2×D (D is the distance between two neighboring pattern units) by reactive ion etching using fluorine- or chlorine-containing gases and a polymer forming gas;
removing the photoresist by one of exposing the silicon wafer to oxygen plasma to bum the photoresist and dipping the wafer into a resist removal solution or solvent;
anisotripically etching the silicon wafer using KOH.

6. The method of claim 1, wherein the mold is fabricated by one of laser ablation, LIGA, wet chemical etching, dry chemical etching, precision mechanical machining, and laser machining.

7. The method of claim 1, wherein the thin metal film is deposited onto the microtextured surface of the polymer electrolyte membrane by one of electroplating, electroless plating, sputtering, evaporation, atomic layer deposition, and chemical vapor deposition.

8. The method of claim 7, wherein the thin metal film is deposited onto the microtextured surface of the polymer electrolyte membrane by electroless plating.

9. The method of claim 7, wherein the thin metal film comprises one of palladium, platinum, niobium, vanadium, iron, tantalum, and an alloy thereof.

10. The method of claim 7, wherein the thin metal film is a composite film comprising multiple metal layers.

11. The method of claim 10, wherein the composite film comprises a first metal layer covered by a second metal layer, wherein said first metal layer comprises a material selected from the group consisting of niobium, vanadium, iron, tantalum, and an alloy thereof; and wherein said second metal layer comprises a material selected from the group consisting of palladium, platinum and an alloy thereof.

12. The method of claim 1, wherein the microstructure on the surface of the polymer electrolyte membrane is produced by a process comprising the step of:
embossing the polymer electrolyte membrane with the mold having a microtextured surface at an elevated temperature.

13. The method of claim 1, wherein the microstructure on the surface of the polymer electrolyte membrane is produce by a process comprising one of the step of:
pressing a polymer electrolyte membrane mixture with the mold having a microtextured surface; and
solidifying a polymer electrolyte membrane mixture on the microtextured surface of the mold.

14. The method of claim 1, wherein the polymer electrolyte membrane is a sulfonated derivative of a polymer selected from a group consisting of polysulfone (PSU), polyimide (PI), polyphenylene oxide (PPO), polyphenylene sulfoxide (PPSO), polyphenylene sulfide (PPS), polyparaphenylene (PPP), polyphenylquinoxaline (PPQ), polyarylketone (PK), polyetherketone (PEK), polyetheretherketone (PEEK), polyetherketone-ketone (PEKK), polyetheretherketone-ketone (PEEKK) polyetherketoneetherketone-ketone (PEKEKK), polybenzazole (PBZ), polybenzimidazole (PBI), and polyaramid polymers.

15. The method of claim 1, wherein the polymer electrolyte membrane is a blended polymer.

16. The method of claim 1, wherein the polymer electrolyte membrane is a composite membrane comprising multiple layers of polymer electrolyte membranes, wherein the multiple layers of polymer electrolyte membranes comprise at least one of blended polymer membrane and unblended polymer membrane.

17. The method of claim 16, wherein the composite membrane is one of a Nafion™ coated with sulfonated PEEK and a PBI membrane coated with sulfonated PEEK.

18. The method of claim 1, further comprising soaking the polymer electrolyte membrane in a soaking composition or a fuel before metal deposition.

19. The method of claim 1, further comprising:
soaking the metal-coated polymer electrolyte membrane in a soaking composition or a fuel after metal deposition; and
recoating the soaked polymer electrolyte membrane with a metal or an alloy by eletroless plating or electroplating.

20. The method of claim 1, wherein the microtextured surface comprises a plurality of protrusions having surfaces not parallel to a central plane of the polymer electrolyte membrane, and wherein the plurality of protrusions occupy a majority of surface areas of the microtextured surface.

21. The method of claim 1, wherein the metal film comprises a metal or an alloy selected from the group consisting of palladium, niobium, vanadium, iron, tantalum, and alloys thereof.

22. A method for producing a metal-coated polymer electrolyte membrane, said method comprising:
microtexturing a surface of a polymer electrolyte membrane; and
depositing a metal film on the microtextured surface of the polymer electrolyte membrane,
wherein the metal film is permeable to protons and hydrogen.

23. The method of claim 22, wherein the microtexturing is achieved by one of sand grinding, wet chemical etching, dry chemical etching and plasma treatment.

24. The method of claim 22, further comprising soaking the polymer electrolyte membrane in one of a soaking composition and a fuel before metal deposition.

25. The method of claim 22, further comprising:
soaking the metal-coated polymer electrolyte membrane in a soaking composition or a fuel after metal deposition; and
recoating the soaked polymer electrolyte membrane with a metal or an alloy by electroless plating or electroplating.

26. A method for producing a metal-coated polymer electrolyte membrane, said method comprising:
fabricating a mold having a microtextured surface;
depositing a metal film on the microtextured surface of said mold,
producing a microstructure on a surface of a polymer electrolyte membrane using the metal-deposited mold having the microtextured surface;
transferring said metal film to said polymer electrolyte membrane, and
wherein the metal film is permeable to protons and hydrogen.

27. A method for producing a metal-coated polymer electrolyte membrane, said method comprising:
soaking a polymer electrolyte membrane in a soaking composition, and
depositing a metal film on a surface of the soaked polymer electrolyte membrane,
wherein the thin metal film is permeable to protons and hydrogen.

28. A method for producing a metal-coated polymer electrolyte membrane, said method comprising:
depositing a first metal film on a surface of a polymer electrolyte membrane,
soaking the polymer electrolyte membrane in a soaking composition, and
depositing a second metal film on top of the first metal film,
wherein the first and second metal films are permeable to protons and hydrogen.

29. A metal-coated polymer electrolyte membrane produced by a method comprising:
fabricating a mold having a microtextured surface;
producing a microstructure on a surface of a polymer electrolyte membrane using the mold having the microtextured surface; and
depositing a metal film on the microtextured surface of the polymer electrolyte membrane,
wherein the metal film is permeable to protons and hydrogen.

30. A metal-coated polymer electrolyte membrane produced by a method comprising:
microtexturing a surface of a polymer electrolyte membrane; and
depositing a metal film on the microtextured surface of the polymer electrolyte membrane,
wherein said metal film is permeable to protons and hydrogen.

31. The metal-coated polymer electrolyte membrane of claim 30, wherein the metal film is further coated with a catalyst.

32. The metal-coated polymer electrolyte membrane of claim 31, wherein the catalyst is one of Pt, Pt alloy, Pt black and Pd black.

33. An electrolyte membrane, comprising:
a polymer electrolyte body,
a microtexture on the surface of the polymer electrolyte body; and
a metal film on the microtextured surface of the polymer electrolyte body,
wherein said metal film is permeable to protons and hydrogen.

34. The electrolyte membrane of claim 33, wherein said metal film is further coated with a porous metal.

35. The electrolyte membrane of claim 34, wherein said porous metal comprises at least one of palladium, platinum, niobium, tantalum, iron, and alloys thereof.

36. The electrolyte membrane of claim 34, wherein said porous metal is palladium and is further coated with particles of platinum or platinum-ruthenium alloy.

37. A fuel cell assembly, comprising:
an anode;
a cathode;
an electrolyte connecting the anode and the cathode; and
a fuel,
wherein said electrolyte is a polymer electrolyte membrane comprising a microtextured surface and a metal film covering said microtextured surface, said metal film is permeable to protons and hydrogen.
